(19) United States
(12) Patent Application Publication
(10) Pub. No.: US 2003/0131162 A1
(43) Pub. Date: Jul. 10, 2003

(54) Non-destructive read FIFO

(76) Inventors: Stacey Secatch, Fort Collins, CO (US); Thomas Henkel, Boeblingen (DE)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/044,091

(22) Filed: Jan. 10, 2002

(51) Int. Cl. G06F 3/00

(52) U.S. Cl. 710/52

(57) ABSTRACT

A non-destructive read FIFO configured to enable data that has been read from an address in the FIFO in a first read cycle to be re-read from the same address in the FIFO in a subsequent read cycle. When the FIFO is full, data stored at the addresses in the FIFO will be read out of the FIFO multiple times in a sequence in which the data was written into the FIFO. The number of times that the stored data is read out of the FIFO in the sequence in which the data was written into the FIFO is preselected. Therefore, the FIFO can be used to cache a loop of instructions that are to be executed a particular number of times.

### TECHNICAL FIELD OF THE INVENTION

The present invention relates to first-in-first-out (FIFO) memory devices and, more particularly, to a non-destructive read FIFO.

### BACKGROUND OF THE INVENTION

A FIFO is a standard implementation of a queue in which data is loaded into the FIFO in a sequence and unloaded from the FIFO in the same sequence in which it was loaded into the FIFO. Informational signals associated with a standard FIFO indicate different conditions of the FIFO, such as whether the FIFO is empty (i.e., whether there is no valid data in the FIFO) and whether it is full (i.e., whether there is no more room in the FIFO and thus no data can currently be written to the FIFO).

Random Access Memory (RAM) devices allow a write and a read to any location in the memory device, but the write and read operations are complex in comparison to FIFO read and write operations. Also, as opposed to FIFOs, many RAM architectures are such that a read and write operation cannot occur during the same state. Furthermore, RAM devices generally have more latency associated with setting up address changes to data being written and/or read. RAM devices, on the other hand, can store much more data than FIFOs.

One major construct in code is a “for” loop, where the same code is executed by a processor many times in sequence. If the first pass through the loop of instructions could be cached, follow-on loops could be executed from memory, which would improve throughput and reduce processing overhead with respect to instruction execution. Otherwise, the same instructions would have to be read out of memory each time the loop is to be executed, which results in a large amount of latency.

Known FIFOs will not work for the purpose of caching a loop of instructions that will need to be executed a given number of times because the stream of instructions through a FIFO is linear, and once a value is unloaded from the FIFO it is lost. RAM would work for this purpose, but it is not a suitable solution because it is generally too slow and would require too much area if implemented as a small cache.

Accordingly, a need exists for a FIFO architecture that can be used for caching loops of instructions that will be executed multiple times.

### SUMMARY OF THE INVENTION

In accordance with the present invention, a non-destructive read FIFO is provided and is configured to enable data that has been read from an address in the FIFO in a first read cycle to be re-read from the same address in the FIFO in a subsequent read cycle. When the FIFO contains data, data stored at the addresses in the FIFO will be read out of the FIFO multiple times in a sequence in which the data was written into the FIFO. The number of times that the stored data is read out of the FIFO in the sequence in which the data was written into the FIFO is preselected. Therefore, the FIFO can be used to cache a loop of instructions that are to be executed a particular number of times.

In accordance with one example embodiment, the non-destructive FIFO is used as a cache to enable a loop of instructions to be executed a desired number of times. An advantage of the FIFO of the present invention over typical cache memory devices that are used for this purpose is that cache memory requires a check to determine if the correct data is in the cache before it is read from the cache. In contrast, if the FIFO of the present invention is used for multiple executions of a loop of instructions, it is known that the data is in the FIFO, and therefore there is no need to check to determine if the correct data is in the FIFO. The loop can be executed multiple times by simply resetting the read pointer to the address of the FIFO containing the first instruction of the loop after the read pointer has been incremented to the address containing the last instruction of the loop.

These and other features and embodiments of the present invention will be described below with reference to the detailed description, drawings and claims.

### BRIEF DESCRIPTION OF THE DRAWINGS

FIG. 1 is a block diagram of a standard FIFO memory device.

FIG. 2 illustrates a high level block diagram of an example embodiment of the non-destructive FIFO memory device of the present invention.

FIG. 3 illustrates a block diagram of the write counter and read counter logic of the non-destructive FIFO memory device shown in FIG. 2.

FIG. 4 is a block diagram illustrating the write and read logic of FIG. 3 combined with the FIFO memory device shown in FIG. 2.

FIG. 5 is a flow chart illustrating an example embodiment of the method of the present invention for non-destructively reading data from the FIFO memory device shown in FIG. 4.

### DETAILED DESCRIPTION OF THE INVENTION

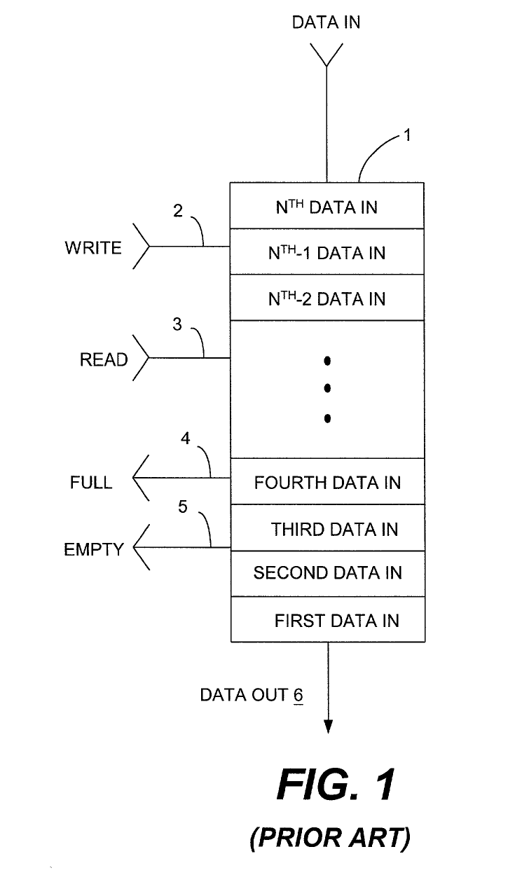

FIG. 1 is a block diagram of a standard FIFO memory device. In a standard FIFO memory device, a read will not be attempted when the empty flag is set and a write will not be attempted when the full flag is set. When the full flag 4 is not set and the write signal 2 is asserted, a new stream of data will be written into the FIFO 1. To accomplish this, the write pointer (not shown) of the standard FIFO 1 will write a data value into the first address and then increment itself to the next address and store the next value in the stream in that address. This process is repeated until a data value has been saved in the last address, which then causes the full flag 4 to be set and the write pointer to be reset to the first address of the FIFO.

When the empty flag 5 is not set and the read signal 3 is asserted, the read pointer (not shown) will point to the first address at which data was stored and will cause the data to be read from that address. The read pointer will then increment itself to the next address at which data was stored and cause the data to be read out of that address. This process continues until the last data value stored has been read out of the last address of the FIFO 1, which causes the empty flag 5 to be set and the read pointer to be reset to the first address of the FIFO 1. Once the empty flag 5 has been set and the write signal 2 is asserted, data will again be written into memory in the above-described manner. The data can then be read out of the FIFO 1 in the manner described above if the empty flag 5 is not set and the read signal 3 is asserted. Reading and writing to FIFO 1 may be done concurrently, as long as the read pointer does not advance in front of the write pointer.

The read and write pointers are automatically reset to the first address of the standard FIFO. The states of the empty and full flags are determined by the condition of the FIFO, and they, in turn, determine when a read and/or write of data can occur. For example, when the empty flag is set, a read cannot occur. The empty flag will be reset after new data has been written into the FIFO. For these reasons, data at an address that has been read once is essentially destroyed because a read at the same location will happen only after the pointers have wrapped around, and new data will have been written at that address.

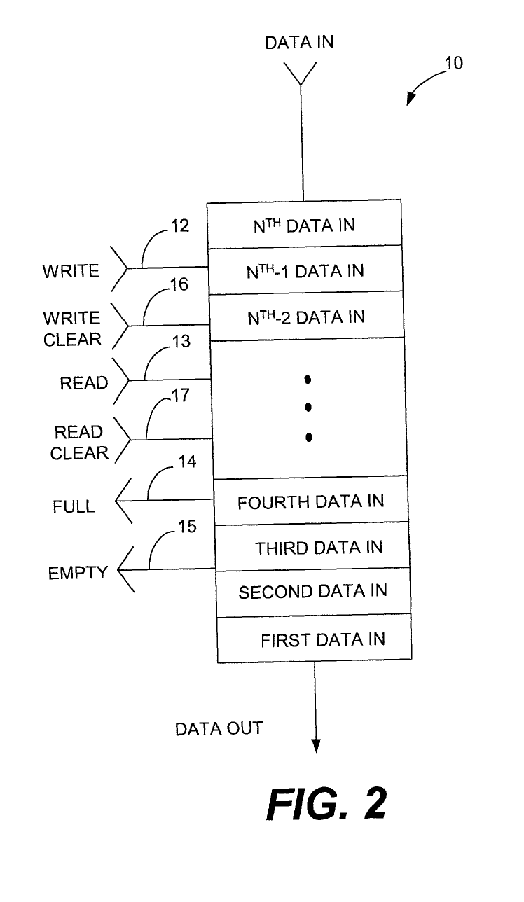

In accordance with the present invention, the read and write logic are independently resettable and the pointers do not wrap around. This allows data that has been read once at any address to be read again from the same address. This, in turn, enables the FIFO of the present invention to be used as a cache memory device that data can be quickly written to and read from the FIFO. FIG. 2 is a block diagram that illustrates an example embodiment of a non-destructive FIFO 10 of the present invention. The non-destructive FIFO 10 includes not only write and read signals 12 and 13, respectively, and full and empty flag outputs, 14 and 15, respectively, but also includes a write clear input 16 and a read clear input 17.

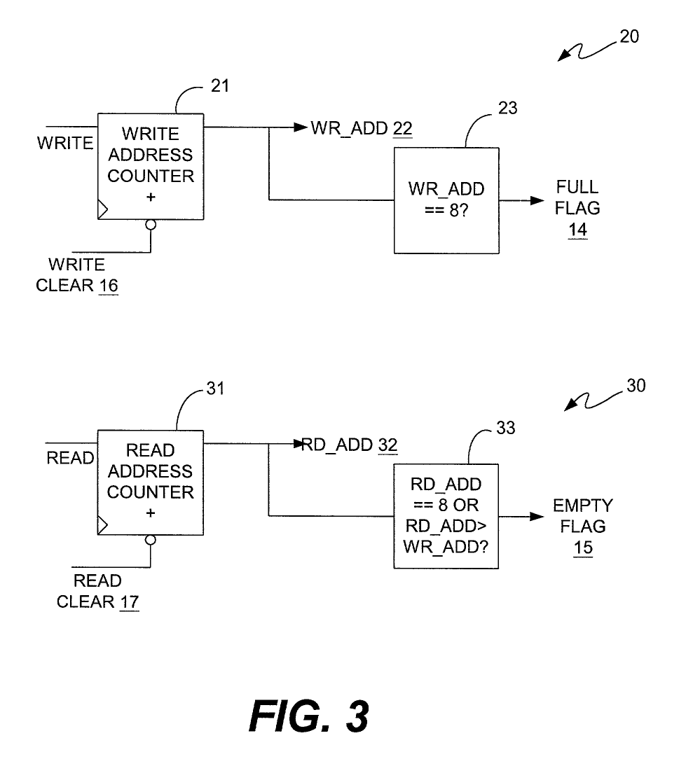

FIG. 3 illustrates a block diagram of read logic 20 and write logic 30 of the present invention in accordance with an example embodiment in which a FIFO having 8 memory addresses is assumed. With reference to the write logic 20, when the write signal 12 is asserted, the write address counter 21 is incremented to the next write address 22. If the full flag 14 is not set at this time, data will be written to the location in the FIFO 10 identified by the write address, WR_ADD 22. Write address decision logic 23 will then determine whether the write address has been incremented to 8. If so, the full flag 14 is set.

With reference to the read logic 30, when the read signal 13 is asserted, the read address counter 31 is incremented to the next read address 32. If the empty flag 15 is not set at this time, data will be unloaded from the location in the FIFO 10 identified by the read address, RD_ADD 32. Read address decision logic 33 will then determine whether the read address has been incremented to 8 OR whether the read address has been incremented to an address greater than the current write address. If either condition is true, the empty flag 15 is set.

As long as the empty flag 15 has not been set and as long as the read signal 13 is asserted, the read address will be incremented and the data will be read from the corresponding read addresses in the FIFO 10. When either of the conditions of block 33 is true, the READ CLEAR signal 17 can be used to reset the read address counter to the first address in the FIFO to be read. As long as the WRITE CLEAR signal 16 is not activated, the write address will remain equal to the last address and the full flag will remain in the previous state. Therefore, each time the read address is equal to the last address in the FIFO or becomes greater than the write address, the READ CLEAR signal 17 can be activated to reset the read address to the first address of the FIFO. The purpose for the condition “OR RD_ADD>WR_ADD” is because it is possible that less than all of the FIFO addresses will be used to store data. For example, a loop of instructions may only have 5 instructions. In this case, the read address counter would be reset when the read address is incremented to 6, and therefore attempts will not be made to read addresses that were not written to by the write pointer.

The WRITE CLEAR signal 16 can be used to control the number of times that the same set of instructions are read out of the FIFO 10. For example, if a loop of instructions is to be executed 10 times, then after the last instruction of the loop has been read out of the FIFO 10, the WRITE CLEAR and READ CLEAR signals 16 and 17 would be activated, the full flag 14 would be reset if active, and the empty flag 15 would be set since the FIFO 10 no longer contains valid data.

The READ CLEAR signal 17 is generated by architecture that is external to the FIFO 10. The external architecture knows that the loop has been completed because some sort of return instruction will have been executed. It knows that if there are more than 8 instructions in that loop, the cache is empty due to the empty flag. Each time the READ CLEAR signal 17 is activated after the full flag 14 has been set, the architecture external to the FIFO 10 (e.g., the architecture of the processor, state machine, etc., utilizing the FIFO 10) will know that a loop has been executed. Therefore, once the correct number of passes through a loop have been made, the external architecture will cause the WRITE CLEAR signal 16 to reset the write address counter and the READ CLEAR signal 17 to reset the read address counter.

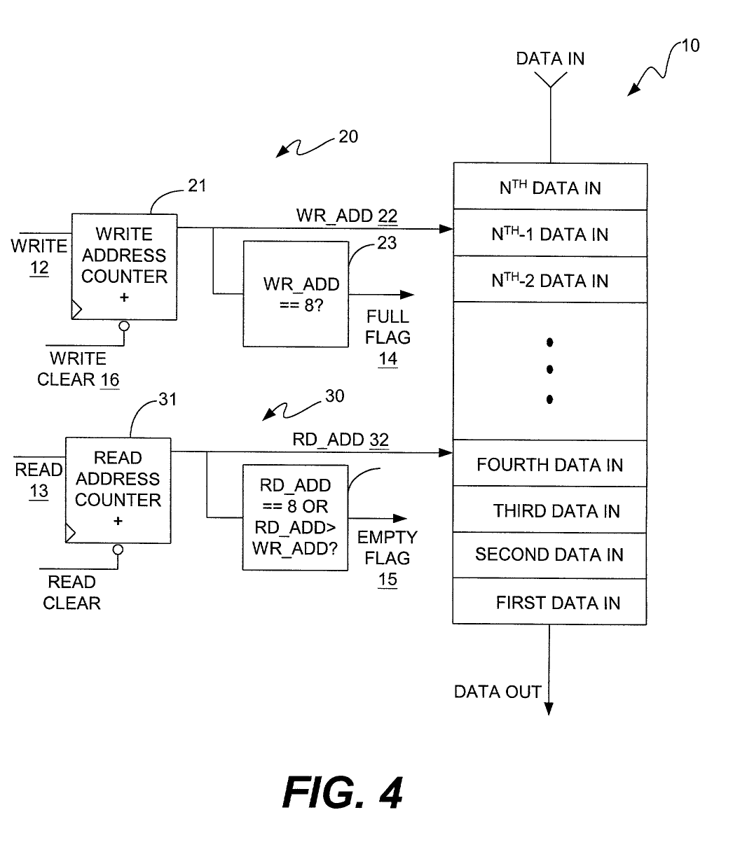

FIG. 4 is a block diagram of the FIFO 10 of the present invention, which illustrates the write and read logic 20 and 30, respectively, shown in FIG. 3. The read address pointer corresponds to RD_ADD 32 and the write address pointer corresponds to WR_ADD 22. Although the pointers are shown as being stationary lines, they are actually binary numbers. Each address in the FIFO 10 has one of these binary numbers associated with it. When a read is being performed, the binary number of the pointer will be carried over a read address bus (not shown), with each line of the read address bus having a digital voltage level on it that corresponds to a 0 or a 1. The bus lines are connected to each storage location in the FIFO such that when certain lines of the bus have digital values that correspond to one of the read addresses of the FIFO, that storage location will be enabled and the data stored therein will be read and output onto an output bus (not shown) of the FIFO 10. The write address bus is configured and operates in a similar fashion, except that the digital values on the write address bus lines will enable the address corresponding to the values on the write address bus and data values on a similarly configured data bus (not shown) will then be stored in the corresponding address location. For ease of illustration, these buses and their connections to the storage elements of the FIFO 10 are not shown.

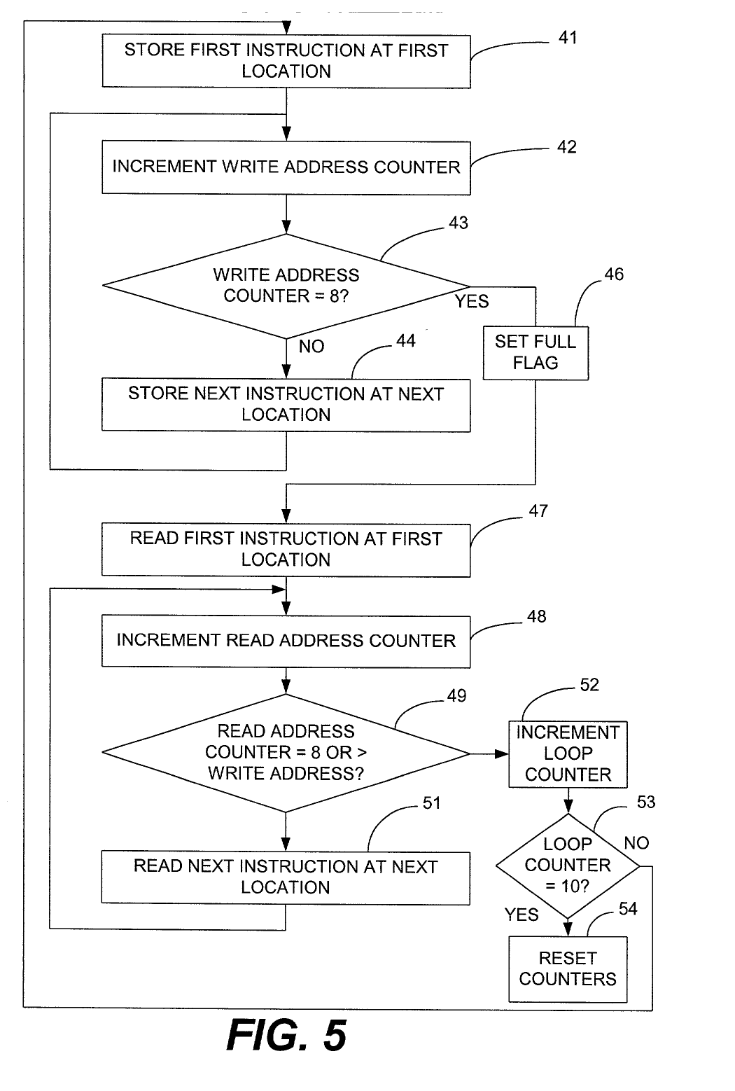

FIG. 5 illustrates the method of the present invention in accordance with the example embodiment of FIG. 4. This example assumes a loop that is to be executed 10 times that comprises 8 instructions. The empty flag is set since this is the first time the loop of instructions has been stored in the FIFO. The write address pointer begins at the first location in the FIFO and stores the first instruction at that location, as indicated by block 41. The write address counter is incremented each time a value is stored in the FIFO, as indicated by block 42. A determination is then made as to whether the write address counter has been incremented to 8, as indicated by decision block 43. If not, the process moves to block 44 and the next value is stored at the next address in the FIFO. The process then returns to decision block 43 and if the write address counter has not yet been incremented to 8, moves again to block 44 and the next value is stored at the next address.

Once the write address counter has been incremented to 8, the full flag is set, as indicated by block 46. When the read signal is asserted, the read address pointer will cause the value stored at the first location in the FIFO to be read out of the FIFO, as indicated by block 47. The read address counter will then be incremented, as indicated by block 48. A determination will then be made as to whether the read address counter is equal to 8 or greater than the current write address, as indicated by block 49. If neither of these conditions is true, the process will proceed to block 51 and the next value stored at the location of the read address pointer will be read out of the FIFO. Each time a value has been read from a location in the FIFO identified by the read address, as indicated by block 52. A determination will then be made as to whether the read address counter has been incremented to 8 OR whether it is greater than the write address, as indicated by block 53. If neither of these conditions are true, the read address counter will be incremented to the next address and the value stored at the address identified by the read address pointer will be read out of the FIFO, as indicated by block 54. The process will continue to return to decision block 53 and then on to block 54 until either of the conditions identified in block 53 is satisfied. Once this happens, the empty flag will be set, as indicated by block 55.

A determination is then made as to whether the ten passes through the loop have been made. This can be accomplished in a number of ways, such as by incrementing a counter when the empty flag has been set, as indicated by block 52, and then determining whether the counter equals ten, as indicated by block 53. If a determination is made that ten passes have not been made, the read address counter is reset, as indicated by block 54. The process then returns to block 47 and proceeds again through the aforementioned steps. If a determination is made at block 53 that ten passes have been completed, then the write address and read address counters are cleared, as indicated by block 54.

It should be noted that the loop of instructions can be greater in number or lesser in number than the number of addresses in the FIFO 10. If the loop has less instructions than the number of addresses in the FIFO 10, attempts will not be made to read the additional addresses because the number of addresses that were written to is known by the read logic 30. If the number of instructions in the loop is greater than the number of addresses in the FIFO, the instructions that can fit in the FIFO will be immediately ready for execution as they are read out of the FIFO. The instructions that did not fit into the FIFO can be fetched while the instructions in the FIFO 10 are being read from the FIFO 10, which reduces latency associated with fetching the instructions.

It should be noted that the present invention has been described with reference to example embodiments, and that the present invention is not limited to the embodiments described herein. Those skilled in the art will understand, in view of the discussion provided herein, that modifications can be made to the embodiments described above without deviating from the scope of the present invention.

What is claimed is:

1. A non-destructive read FIFO, the non-destructive read FIFO being configured to enable data that has been read from an address in the FIFO in a first read cycle to be re-read from the same address in the FIFO in a subsequent read cycle.

2. The non-destructive read FIFO of claim 1, wherein when the FIFO is full, data stored at the addresses in the FIFO will be read out of the FIFO multiple times in a sequence in which the data was written into the FIFO.

3. The non-destructive read FIFO of claim 1, wherein the number of times that data stored at the addresses in the FIFO will be read out of the FIFO in the sequence in which the data was written into the FIFO is controlled by a source external to the FIFO.

4. The non-destructive read FIFO of claim 3, wherein the non-destructive read FIFO is within a processor, and wherein the data stored at addresses in the FIFO corresponds to a subroutine of instructions that is to be executed a plurality of times by the processor, the processor comprising logic corresponding to said external source that controls the number of times the data stored at the addresses in the FIFO is read out of the FIFO in the sequence in which the data was written into the FIFO.

5. The non-destructive read FIFO of claim 4, wherein the FIFO comprises a write signal input, a read signal input and write clear input and a read clear input, the FIFO comprising a full flag output and an empty flag output, wherein each time the subroutine of instructions is read out of the FIFO, the read clear signal is asserted, thereby causing a read address pointer of the FIFO to be reset to a first address at which a first instruction of the subroutine of instructions was written, and wherein after the subroutine of instructions has been read out of the FIFO a preselected number of times, an empty flag is set, which prevents any more of the instructions from being read out of the FIFO until the FIFO has been filled with new data.

6. The non-destructive read FIFO of claim 1, wherein the non-destructive read FIFO comprises write logic and read logic, the write logic comprising write address incrementer logic and write address comparison logic, the write address incrementer logic incrementing the write address each time data is written to an address in the FIFO, the write address comparison logic comparing the incremented write address to a preselected number, wherein when the incremented write address is determined by the write address comparison logic to be equal to the preselected number, a full flag is set and no more data is written to the FIFO.

7. The non-destructive read FIFO of claim 1, wherein the non-destructive read FIFO comprises write logic and read logic, the read logic comprising read address incrementer logic and read address comparison logic, the read address incrementer logic incrementing the read address each time data is written to an address in the FIFO, the read address comparison logic comparing the incremented read address to a preselected number and to a current write address, wherein when the incremented read address is determined by the read address comparison logic to be equal to the preselected number or to be greater than the current write address, an empty flag is set and a determination is made as to whether the read address should be reset to a first address at which data was written to in the FIFO.

8. The non-destructive read FIFO of claim 7, wherein when a source external to the FIFO determines that the condition of whether the incremented read address is equal to the preselected number or greater than the current write address has been true a preselected number of times, the external source prevents additional reads of the data from the FIFO from occurring until the FIFO has been filled with new data and a full flag has been set.

9. A non-destructive read FIFO comprising:
a write signal input, a read signal input, write clear input, a read clear input, a full flag output and an empty flag output;
write logic comprising write address incrementer logic and write address comparison logic, the write address incrementer logic incrementing the write address each time data is written to an address in the FIFO, the write address comparison logic comparing the incremented write address to a preselected number, wherein when the incremented write address is determined by the write address comparison logic to be equal to the preselected number, the full flag is set; and
read logic comprising read address incrementer logic and read address comparison logic, the read address incrementer logic incrementing the read address each time data is written to an address in the FIFO, the read address comparison logic comparing the incremented read address to a preselected number and to a current write address, wherein when the incremented read address is determined by the read address comparison logic to be equal to the preselected number or to be greater than the current write address, the empty flag is set.

10. The non-destructive read FIFO of claim 9, wherein when a source external to the FIFO determines that the condition of whether the incremented read address is equal to the preselected number or greater than the current write address has been true a preselected number of times, the external source prevents additional reads of the data from the FIFO from occurring until new data has been stored in the FIFO and the full flag has been set.

11. The non-destructive read FIFO of claim 10, wherein the non-destructive read FIFO is within a processor, and wherein the data stored at addresses in the FIFO corresponds to a subroutine of instructions that is to be executed a plurality of times by the processor, the processor comprising logic corresponding to said external source that controls the number of times the data stored at the addresses in the FIFO is read out of the FIFO in the sequence in which the data was written into the FIFO.

12. The non-destructive read FIFO of claim 11, wherein each time the subroutine of instructions is read out of the FIFO, the read clear signal is asserted, thereby causing a read address pointer of the FIFO to be reset to a first address at which a first instruction of the subroutine of instructions was written, and wherein after the subroutine of instructions has been read out of the FIFO a preselected number of times, the empty flag is set, which prevents any more of the instructions from being read out of the FIFO.

13. A method for reading data values stored at addresses in a FIFO out of the FIFO in a manner that does not destroy the stored data values so that the stored data values can be re-read from the FIFO in a same sequence in which the data values were stored in the FIFO a multiplicity of times, the method comprising the steps of:
storing data values at addresses in the FIFO;
when an empty flag has not been set and a read signal is asserted, reading the data values out of the FIFO in a same sequence in which the data values were stored in the FIFO;
when all of the data values have been read out of the FIFO, determining whether the data values should again be read out of the FIFO in the sequence in which the data values were stored in the FIFO; and
if a determination is made that the data values should again be read out of the FIFO, reading the data values out of the FIFO in the sequence in which the data values were written into the FIFO.

14. The method of claim 13, wherein the number of times that data stored at the addresses in the FIFO will be read out of the FIFO in the sequence in which the data was written into the FIFO is controlled by a source external to the FIFO.

15. The method of claim 14, wherein the data stored at addresses in the FIFO corresponds to a subroutine of instructions that is to be executed a plurality of times by a processor, the processor comprising logic corresponding to said external source that controls the number of times the data stored at the addresses in the FIFO is read out of the FIFO in the sequence in which the data was written into the FIFO.

16. The method of claim 15, wherein the FIFO comprises a write signal input, a read signal input, a write clear input, a read clear input, a full flag output and an empty flag output, wherein each time the subroutine of instructions is read out of the FIFO, the read clear signal is asserted, thereby causing a read address pointer of the FIFO to be reset to a first address at which a first instruction of the subroutine of instructions was written, and wherein after the subroutine of instructions has been read out of the FIFO a preselected number of times, an empty flag is set, which prevents any more of the instructions from being read out of the FIFO until the FIFO has been filled with new data.
